(19) United States
(12) Patent Application Publication
(10) Pub. No.: US 2015/0098457 A1
(43) Pub. Date: Apr. 9, 2015

(54) ENABLING INTERNET PROTOCOL CONNECTIVITY ACROSS MULTI-HOP MOBILE WIRELESS NETWORKS VIA A SERVICE ORIENTED ARCHITECTURE

(71) Applicant: QUALCOMM Incorporated, San Diego, CA (US)

(72) Inventors: Arungundram Chandrasekaran Mahendran, San Diego, CA (US); Xiaolong Huang, San Jose, CA (US); Ramanathan Viswanathan, San Diego, CA (US); Xun Luo, San Diego, CA (US)

(73) Assignee: QUALCOMM Incorporated, San Diego, CA (US)

(21) Appl. No.: 14/283,982

(22) Filed: May 21, 2014

Related U.S. Application Data
(60) Provisional application No. 61/888,466, filed on Oct. 8, 2013.

(51) Int. Cl. H04W 48/10; H04W 76/02

(52) U.S. Cl. CPC H04W 48/10; H04W 76/02; H04W 84/18
USPC 370/338

(57) ABSTRACT

The disclosure provides a method, apparatus, and computer program product directed towards enabling internet protocol (IP) connectivity across multi-hop wireless networks. A virtual adapter is generated to facilitate creating a virtual link layer between a virtual link layer node and at least one other virtual link layer node. The virtual link layer is then interfaced with an IP layer via the virtual adapter, such that data transmitted over the virtual link layer is accessible to the IP layer via the virtual adapter.

### CROSS-REFERENCE TO RELATED APPLICATIONS

This application claims priority to and the benefit of provisional patent application No. 61/888,466, filed in the United States Patent and Trademark Office on Oct. 8, 2013, the entire content of which is incorporated herein by reference.

### BACKGROUND

1. Field

Aspects of the present disclosure relate generally to wireless communication systems, and more particularly, to enabling internet protocol (IP) connectivity across multi-hop wireless networks.

2. Background

Wireless communication networks are widely deployed to provide various communication services such as telephony, video, data, messaging, broadcasts, and so on. Such networks, which are usually multiple access networks, support communications for multiple users by sharing the available network resources.

In a service-oriented architecture (SOA), one or more nodes may communicate with each other to offer each other interoperable services. In this context, a service can be thought of as an autonomous unit of functionality implemented by self-contained software. A typical implementation of service-oriented architecture functionality may include a number of computer nodes interconnected by a computer network. Each node may communicate with the other nodes to identify services offered by the other nodes. Each node may also advertise one or more services to the other nodes.

For a first node to invoke a service offered by a second node in an SOA, the first node may transmit a remote procedure call to the second node, the remote procedure call being supported by the selected service. The remote procedure call may include one or more arguments or other parameters provided by the first node. The second node may respond to the remote procedure call by executing one or more software functions based on the type of call and/or the parameters provided. In some examples, the second node may provide a result of the remote procedure call to the first node.

To provide a device with connectivity to devices that are potentially “multiple hops” away (i.e., connectivity to devices that are not directly connected to the device), it would be desirable to provide such connectivity with a minimum amount of modification to the IP stack. In this way, application and libraries that operate on the IP stack do not have to recognize the connectivity activity below the IP stack.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide methods, apparatuses, computer program products, and processing systems directed towards enabling internet protocol (IP) connectivity across multi-hop wireless networks. In one aspect, the disclosure provides a method to facilitate a mobile adhoc network, which includes generating a virtual adapter to facilitate creating a virtual link layer between a virtual link layer node and at least one other virtual link layer node. The method further includes interfacing the virtual link layer with an IP layer via the virtual adapter, such that data transmitted over the virtual link layer is accessible to the IP layer via the virtual adapter.

In another aspect, a device comprising a virtual adapter circuit and a routing circuit is disclosed. Here, the virtual adapter circuit is configured to generate a virtual adapter to facilitate creating a virtual link layer between a virtual link layer node and at least one other virtual link layer node, whereas the routing circuit configured to interface the virtual link layer with an IP layer via the virtual adapter, such that data transmitted over the virtual link layer is accessible to the IP layer via the virtual adapter.

In a further aspect, another device is disclosed. Here, the device comprises means for generating a virtual adapter to facilitate creating a virtual link layer between a virtual link layer node and at least one other virtual link layer node, and means for interfacing the virtual link layer with an IP layer via the virtual adapter, such that data transmitted over the virtual link layer is accessible to the IP layer via the virtual adapter.

In yet another aspect, a non-transitory machine-readable storage medium having one or more instructions stored thereon is disclosed. Here, when executed by at least one processor, the one or more instructions cause the at least one processor to generate a virtual adapter to facilitate creating a virtual link layer between a virtual link layer node and at least one other virtual link layer node, and interface the virtual link layer with an IP layer via the virtual adapter, such that data transmitted over the virtual link layer is accessible to the IP layer via the virtual adapter.

These and other disclosed aspects will become more fully understood upon a review of the detailed description, which follows. Other aspects, features, and aspects of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 shows a block diagram of an example system for implementing Internet Protocol (IP) connectivity;

FIG. 2 shows a block diagram of one example of a wireless communications system;

FIG. 3 is a block diagram conceptually illustrating an example of a set of communication layers;

FIG. 4 illustrates an exemplary virtual network of devices connected via a service oriented architecture (SOA) bus according to an aspect of the disclosure;

FIG. 5 is a block diagram illustrating an example of a hardware implementation for a user equipment employing a processing system according to some aspects of the disclosure;

FIG. 6 is a block diagram illustrating exemplary device identifier components according to an aspect of the disclosure;

FIG. 7 is a flow chart illustrating an exemplary device identifier generation procedure according to some aspects of the disclosure;

FIG. 8 is a flow chart illustrating a process for generating an IP address;

FIG. 9 is a call flow diagram illustrating a process for resolving a device identifier conflict;

FIG. 10 is a block diagram illustrating exemplary routing components according to an aspect of the disclosure;

FIG. 11 is a flow chart illustrating an exemplary routing procedure according to some aspects of the disclosure;

FIG. 12 is a conceptual diagram illustrating an example utilizing a connected dominating set for transmitting broadcast messages in an access network;

FIG. 13 is a call flow diagram and a simplified schematic diagram illustrating an exemplary process for L3 message processing for FMG creation;

FIG. 14 is a block diagram illustrating exemplary virtual adapter generation components according to an aspect of the disclosure; and

FIG. 15 is a flow chart illustrating an exemplary virtual adapter generation procedure according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

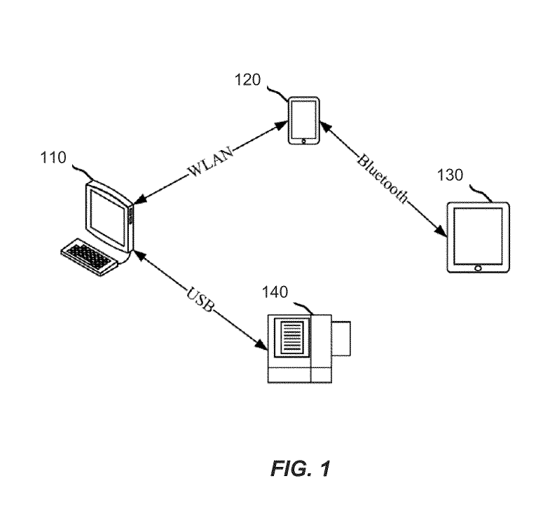

FIG. 1 illustrates an example a system 100 in which various devices including personal computer 110, smartphone 120, tablet computer 130, and printer 140 communicate with each other at a peer-to-peer level. In a particular aspect, it is contemplated that each of devices 110, 120, 130, and 140 are coupled via a service oriented architecture (SOA), wherein respective services provided by each device are available to all other devices via the SOA architecture.

It should be appreciated that an SOA-enabled device may comprise multiple physical adapters, which enable it to interface with various technologies. As shown in FIG. 1, for example, personal computer 110 is configured to communicate with smartphone 120 over a wireless local area network (WLAN) connection (e.g., as an ad-hoc WLAN connection and/or through a WLAN switch, access point, or router). Personal computer 110 is also configured to communicate with printer 140 over a Universal Serial Bus (USB) connection. Smartphone 120 is configured to communicate with tablet computer 130 over a Bluetooth wireless connection.

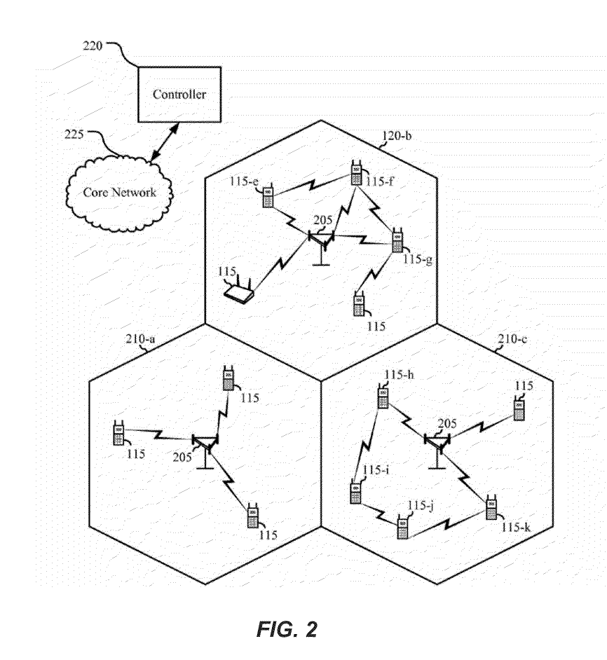

Turning to FIG. 2, a block diagram illustrates an exemplary wireless communications system 200 in which services may be implemented over an SOA bus as described above in FIG. 1. The system 200 includes base stations 205, devices 115, a base station controller 220, and a core network 225 (the controller 220 may be integrated into the core network 225). The system 200 may support operation on multiple carriers (waveform signals of different frequencies).

In the example of FIG. 2, various devices may communicate with the core network 225 through one or more base stations 205. Additionally, certain devices 115 may establish peer-to-peer communications with each other. A group of such devices 115 may cooperate with each other to establish a peer-to-peer network. For example, device 115-e, device 115-f, and device 115-g may leverage a peer-to-peer connection between device 115-e and device 115-f and the peer-to-peer connection between device 115-f and device 115-g to establish a peer-to-peer network between the three devices 115.

The devices 115 may further cooperate to implement a service-oriented architecture (SOA) bus over the peer-to-peer network, and establish IP connectivity over the SOA bus. In this way, an independent virtual link layer network may be established among devices 115-e, 115-f without reliance on base station 205 or core network 225. However, in certain examples, one or more of the devices 115 may advertise a service over the SOA bus which makes use of a connection to the core network 225 through a base station 205. For example, device 115-e may download a file from the core network 225 and stream the file to device 115-g over the SOA bus between device 115-e, device 115-f, and device 115-g.

A device need not be in communication with a base station 205 to join a peer-to-peer network that provides SOA services over an SOA bus. As shown in FIG. 2, device 115-i and device 115-j may each implement peer-to-peer connections with other devices 115 without communicating with a base station 205. Using these peer-to-peer connections, an SOA bus may be implemented among device 115-h, device 115-i, device 115-j, and device 115-k.

It should be further appreciated that the base stations 205 may wirelessly communicate with the devices 115 via a base station antenna (not shown). The base stations 205 may communicate with the devices 115 under the control of the base station controller 220 via multiple carriers. Each of the base station 205 sites may provide communication coverage for a respective geographic area. The coverage area for each base station 205 here is identified as 210-a, 210-b, or 210-c. The coverage area for a base station may be divided into sectors (not shown, but making up only a portion of the coverage area). The system 200 may include base stations 205 of different types (e.g., macro, micro, and/or pico base stations). There may be overlapping coverage areas for different technologies.

The devices 115 may be dispersed throughout the coverage areas 210. The devices 115 may be referred to as mobile stations, mobile devices, access terminals (ATs), user equipment (UEs), subscriber stations (SSs), subscriber units, in addition to stationary devices. The devices 115 may include, but are not limited to, cellular phones and wireless communications devices, but may also include desktop computers, printers, servers, set-top boxes, televisions and other media players, personal digital assistants (PDAs), other handheld devices, netbooks, notebook computers, etc.

As shown in FIGS. 1 and 2, certain devices may not directly communicate with a base station. For example, in cell 210-c, various devices 115 are shown which do not have an established wireless connection to the base station 205. As further shown in FIGS. 1 and 2, certain devices may communicate directly with each other without routing messages through a base station 205. By communicating with each other, either directly or indirectly, the devices may cooperate to establish an SOA bus, in which devices are able to advertise software services to other devices on the SOA bus, and discover and invoke each other's services over the SOA bus. In certain examples, communications between devices over the implemented SOA bus may occur independent of the base stations 205 or their associated core network 225. Alternatively, one or more communications over the SOA bus may occur through a base station 205.

### Exemplary Virtual Link Layer Architecture

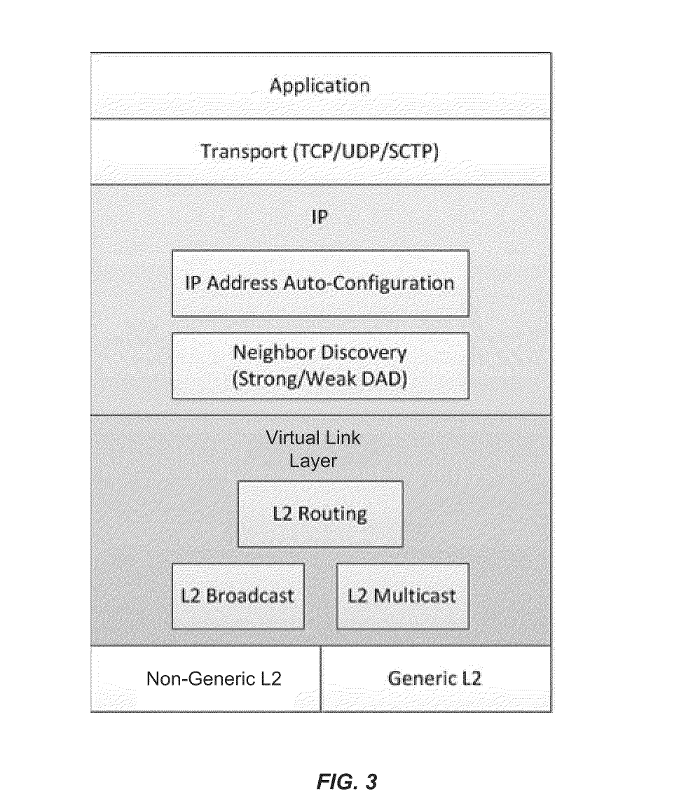

Referring now to FIG. 3, a virtual link layer entity, which may be implemented by any of various SOA-enabled devices, is illustrated. The virtual link layer is shown in FIG. 3 as an interface between a Layer-2 (L2) SOA and an IP layer. To this end, it should be appreciated that an SOA may be implemented via a generic or non-generic architecture, as shown. For instance, AllJoyn is an example of a non-generic open-source SOA known in the art. Moreover, it is contemplated that the various aspects of the disclosure may be implemented utilizing any of various L2 architectures. In an aspect, the virtual link layer may utilize a virtual adapter service to create one or more virtual adapters that are capable of interfacing with the system IP stack. When there are multiple virtual adapters created, they may belong to different IP subnets.

FIG. 3 illustrates how the disclosed virtual link layer may facilitate providing SOA-enabled devices with L2 operations for applications that run on top of this layer. Current systems provide application layers and transport layers that are provided with connectivity through a conventional IP layer, as shown in FIG. 3. However, as also shown in FIG. 3, the disclosed virtual link layer separates the IP layer from L2, and manages the transmission of data to a target node. That is, the virtual link layer enables the assembly of a multi-hop network of wireless devices into a single L2 link, performing L2 routing based on an SOA device ID, discussed in further detail below.

In an aspect, the virtual link layer provides L2 functionality, which includes packet forwarding. In particular, because the virtual link layer lies between the conventional IP layer and the L2 entity (e.g., the AllJoyn entity or the generic L2 entity), a platform is provided which allows the IP layer to see only one hop when forwarding data packets, which desirably reduces the complexity of multi-hop connectivity.

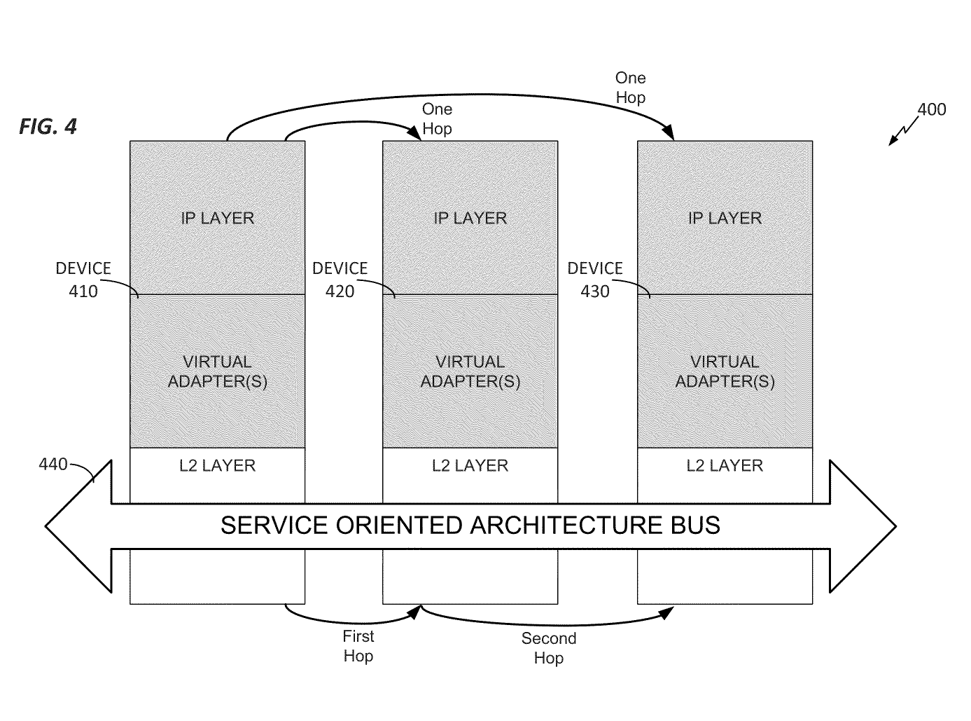

In FIG. 4, for instance, an exemplary network of SOA-enabled devices is shown illustrating how multiple hops for data packet routing are known to the virtual link layer, but not the IP layer. As shown, a virtual link layer network 400 comprises device 410, device 420, and device 430, wherein virtual link adapters respectively separate the IP layers from the L2 layers in each of SOA-enabled devices. Here, it is contemplated that each of devices 410, 420, and 430 may generate a unique SOA device identifier (ID), referred to herein as an SOA device ID, to identify itself within the virtual link layer network 400 via SOA bus 440. In an aspect, from the point of view of the IP stack of any SOA-enabled device, an SOA device ID is an L2 device ID. Moreover, an SOA device ID enables packet forwarding via the SOA bus 440 by uniquely identifying the device in the virtual link layer network 400 in a manner that makes devices appear, to the IP layer, as one hop away from any other device in the virtual link layer network 400.

### Exemplary Virtual Link Layer Implementations

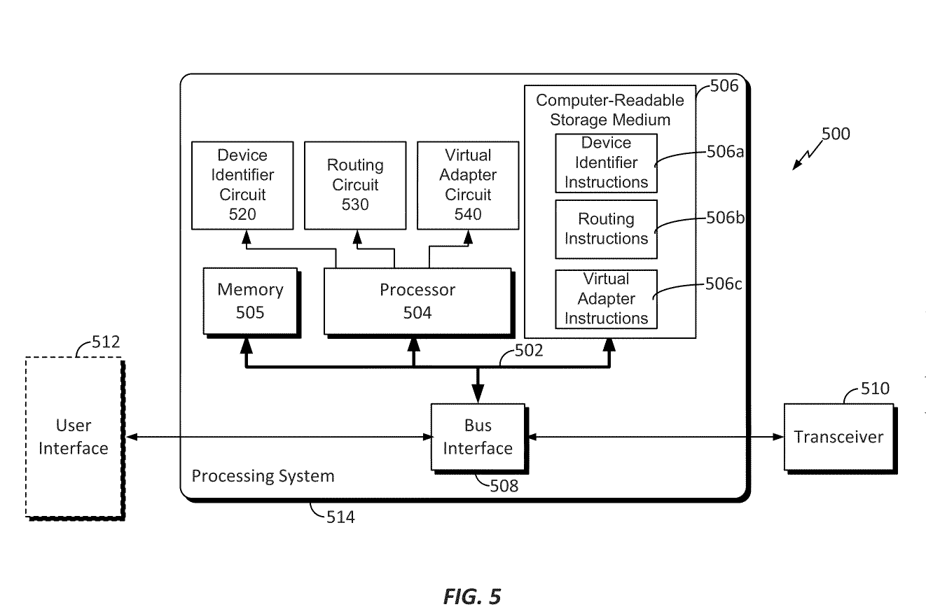

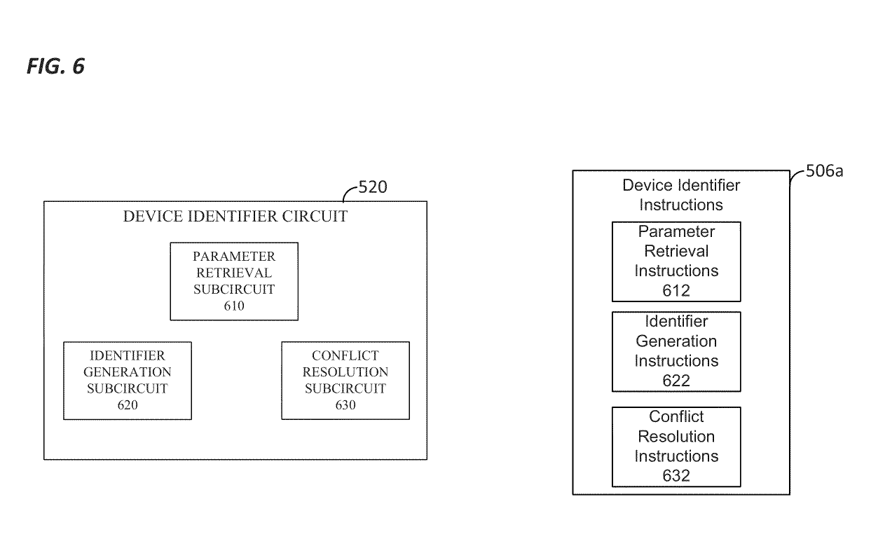

Referring next to FIG. 5, a conceptual diagram illustrating an exemplary hardware implementation for an SOA-enabled device 500 employing a processing system 514, wherein device 500 may be any SOA-enabled device including, for example, any of the SOA-enabled devices discussed with reference to FIGS. 1-4. In accordance with various aspects of the disclosure, an element, or any portion of an element, or any combination of elements may be implemented with a processing system 514 that includes one or more processors 504. Examples of processors 504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 504, as utilized in device 500, may be used to implement any one or more of the processes described below and illustrated in FIGS. 6-15.

In this example, the processing system 514 may be implemented with a bus architecture, represented generally by the bus 502. The bus 502 may include any number of interconnecting buses and bridges, including an SOA bus, depending on the specific application of the processing system 514 and the overall design constraints. The bus 502 links together various circuits including one or more processors (represented generally by the processor 504), a memory 505, and computer-readable media (represented generally by the computer-readable medium 506). The bus 502 may also link various other circuits such as timing sources, peripherals, voltage regulators, and power management circuits, which are well known in the art, and therefore, will not be described any further. A bus interface 508 provides an interface between the bus 502 and a transceiver 510. The transceiver 510 provides a means for communicating with various other apparatus over a transmission medium. Depending upon the nature of the apparatus, a user interface 512 (e.g., keypad, display, speaker, microphone, joystick) may also be provided.

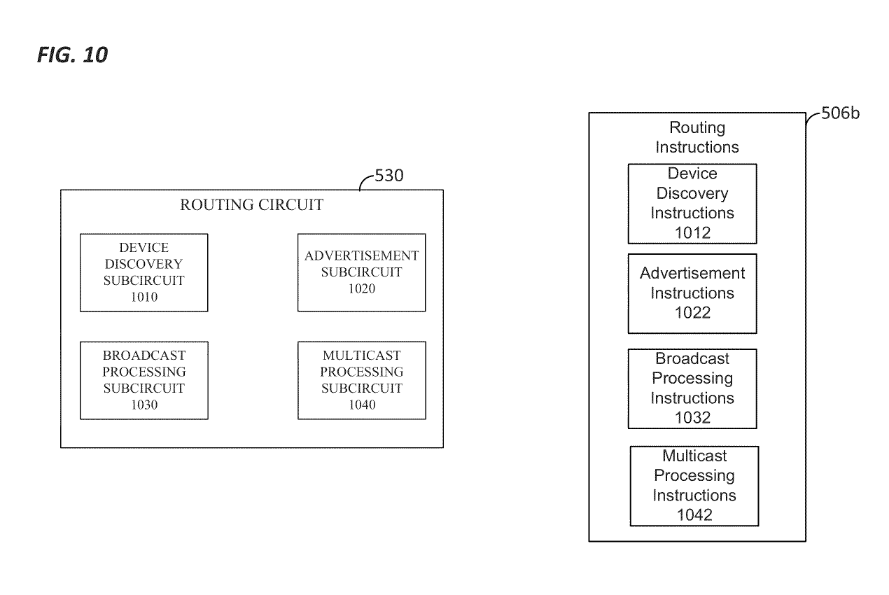

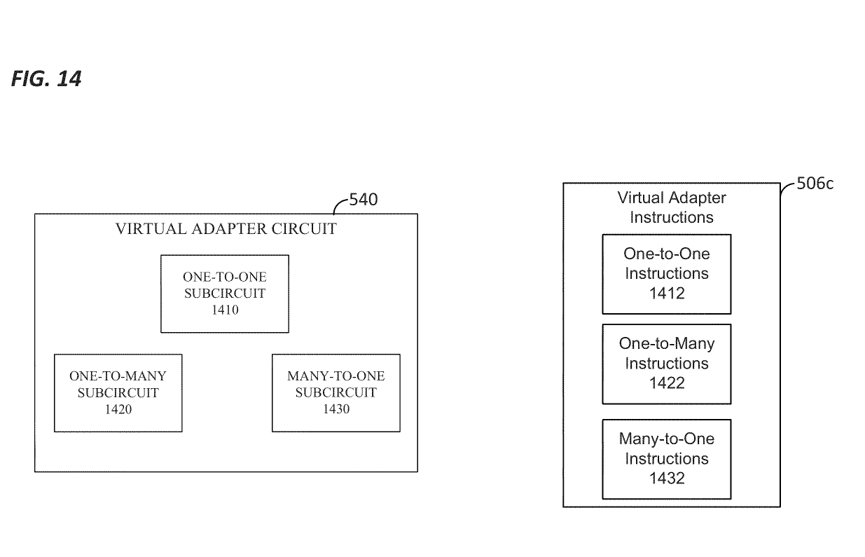

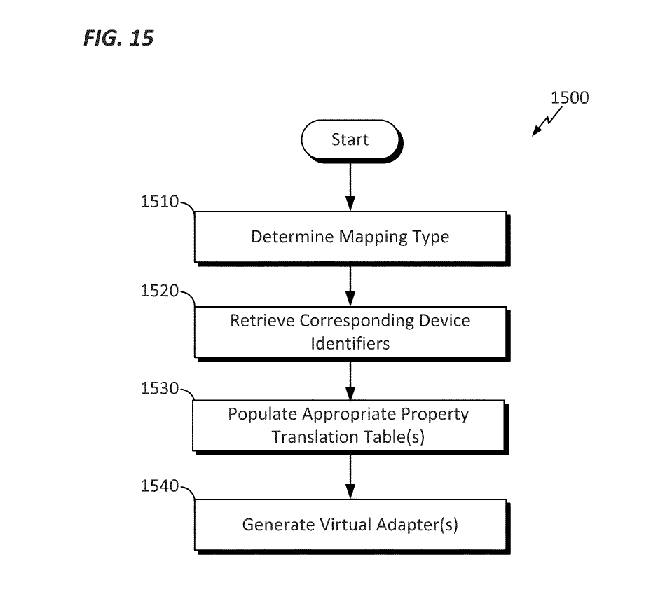

In an aspect of the disclosure, computer-readable medium 506 is configured to include various instructions 506a, 506b, and/or 506c to facilitate enabling IP connectivity via an SOA architecture, as shown. In a similar aspect, such enabling can instead be implemented via hardware by coupling processor 504 to any of circuits 520, 530, and/or 540, as shown. Moreover, it is contemplated that the enabling may be performed by any combination of instructions 506a, 506b, and/or 506c, as well as any combination of circuits 520, 530, and/or 540. In a particular aspect of the disclosure, instructions 506a and circuit 520 are directed towards generating an SOA device identifier, which is discussed in further detail with reference to FIGS. 6-9; instructions 506b and circuit 530 are directed towards routing data via an SOA bus, which is discussed in further detail with reference to FIGS. 10-13; and instructions 506c and circuit 540 are directed towards generating virtual adapters, which is discussed in further detail with reference to FIGS. 14-15.

Referring back to the remaining elements of FIG. 5, it should be appreciated that processor 504 is responsible for managing the bus 502 and general processing, including the execution of software stored on the computer-readable medium 506. The software, when executed by the processor 504, causes the processing system 514 to perform the various functions described below for any particular apparatus. The computer-readable medium 506 may also be used for storing data that is manipulated by the processor 504 when executing software.

One or more processors 504 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 506. The computer-readable medium 506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 506 may reside in the processing system 514, external to the processing system 514, or distributed across multiple entities including the processing system 514. The computer-readable medium 506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

### Virtual Link Layer Implementation Overview

In an aspect of the disclosure, virtual adapter circuit 540 and/or virtual adapter instructions 506c may configured to generate a virtual adapter to facilitate creating a virtual link layer between a virtual link layer node and at least one other virtual link layer node. Routing circuit 530 and/or routing instructions 506b may then be configured to interface the virtual link layer with an IP layer via the virtual adapter, such that data transmitted over the virtual link layer is accessible to the IP layer via the virtual adapter. In an exemplary implementation, the virtual link layer node and the at least one other virtual link layer node are connected to the virtual link layer via a same type of access network. In another implementation, however, the virtual link layer node and the at least one other virtual link layer node are connected to the virtual link layer via different access network types. For instance, the different access network types may comprise a Bluetooth network, a wireless local area network (WLAN), a wireless wide area network (WWAN), an Ethernet network, or any of a plurality of other network types generally known in the art. Subsets of the aforementioned network types are also contemplated including, for example, Wireless LAN Direct, Long-Term Evolution (LTE) Direct, LTE D2D, and Universal Mobile Telecommunications System (UMTS).

### Device Identifier Generation

In another aspect of the disclosure, each of device identifier circuit 520 and device identifier instructions 506a are directed towards deriving a device identifier associated with a virtual link layer node. Such derivation may, for example, be based on aspects of a virtual link layer network on which the virtual link layer node is deployed (e.g., a Layer 2 address), or aspects of the physical access network connecting the virtual link layer node with other virtual link layer nodes (e.g., a MAC address).

Furthermore, as illustrated in FIG. 6, each of device identifier circuit 520 and device identifier instructions 506a may facilitate such derivation via any of a plurality of subcomponents. For instance, device identifier circuit 520 may comprise parameter retrieval sub-circuit 610, identifier generation sub-circuit 620, and conflict resolution sub-circuit 630, whereas device identifier instructions 506a may comprise parameter retrieval instructions 612, identifier generation instructions 622, and conflict resolution instructions 632.

In this particular example, because the device identifier may be based on aspects of a virtual link layer network on which the virtual link layer node is deployed, either of parameter retrieval sub-circuit 610 and/or parameter retrieval instructions 612 may be directed towards retrieving those aspects. Such aspects may, for instance, include determining whether the device's underlying SOA architecture is non-generic (e.g., AllJoyn) or generic. If the device's underlying SOA architecture is AllJoyn, either of identifier generation sub-circuit 620 and/or identifier generation instructions 622 may then be configured to utilize an existing identifier of the virtual link layer node associated with the AllJoyn network as the device identifier. Otherwise, if the underlying SOA architecture is generic, either of identifier generation sub-circuit 620 and/or identifier generation instructions 622 may be configured to derive the device identifier from other parameters retrieved by parameter retrieval sub-circuit 610 and/or parameter retrieval instructions 612. For instance, as will be discussed in further detail below, such derivation may comprise deriving the device identifier from an existing MAC address associated with a physical access network (e.g., Ethernet network, Bluetooth network, etc.), and/or a network time protocol (NTP) time associated with the virtual link layer node. Each of identifier generation sub-circuit 620 and/or identifier generation instructions 622 may then be further configured to derive the device identifier by performing a hash computation, wherein the inputs of the hash computation are the existing MAC address and the NTP associated with the virtual link layer node. Each of identifier generation sub-circuit 620 and/or identifier generation instructions 622 may also be configured to derive the device identifier according to different bit lengths.

As will be discussed in further detail below, many safeguards may be implemented to ensure that the derived device identifier is indeed unique. To facilitate such safeguarding, conflict resolution sub-circuit 630 and/or conflict resolution instructions 632 may be included, as shown. Specifically, either of conflict resolution sub-circuit 630 and/or conflict resolution instructions 632 may be directed towards ensuring that either the device identifier itself, or parameters used to generate the device identifier, are indeed unique.

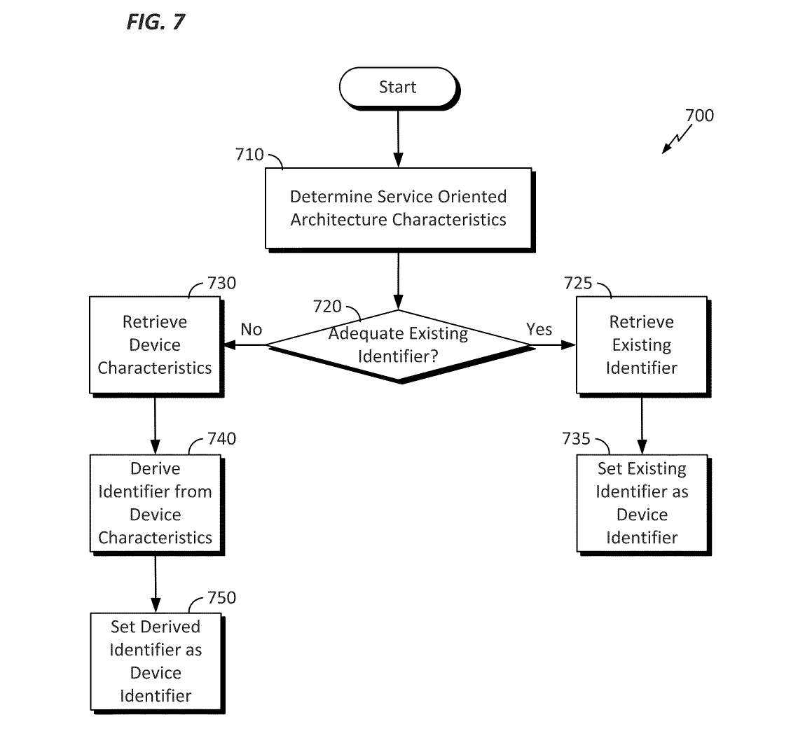

Referring next to FIG. 7, a flowchart illustrating an exemplary device identifier generation procedure in accordance with an aspect of the present disclosure is provided. Here, it should be appreciated that process 700 may be performed by any virtual link layer node including, for example, any of the aforementioned SOA-enabled devices discussed with reference to FIGS. 1-6. As illustrated, process 700 begins at act 710 where characteristics of the virtual link layer node's underlying SOA architecture are determined Such characteristics may, for example, include determining whether the underlying SOA architecture is generic or non-generic. Depending on the type of underlying SOA architecture, process 700 may then determine if an existing identifier may be used as the device identifier. If, for instance, the underlying SOA architecture is an Alljoyn architecture, the existing Alljoyn identifier for the device may be used as the device identifier. Accordingly, at act 720, process 700 may comprise determining whether an existing identifier is adequate (e.g., whether an Alljoyn identifier exists). If so, the existing identifier may be retrieved at act 725, and subsequently set as the device identifier at act 735.

If no existing identifier is adequate, however, process 700 may proceed to derive the device identifier via a computation of other characteristics. For instance, as stated previously, such characteristics may include a MAC address and NTP associated with the device, which are retrieved at act 730. At act 740, process 700 may then derive the device identifier from these retrieved characteristics. For example, act 740 may comprise performing the aforementioned hash computation, wherein the inputs of the hash computation are the existing MAC address and the NTP associated with the virtual link layer node. Process 700 may then conclude with the identifier derived at act 740 being set as the device identifier at act 750.

In various aspects of the disclosure, it is contemplated that a device identifier may take any suitable length, and may be fixed or varying, e.g., taking a bit length of 48, 64, or 128 bits. As stated previously, the device identifier may simply be the AllJoyn globally unique identifier (GUID) number. That is, because the AllJoyn GUID is known to be unique to the device, this identifier may be reused by the virtual link layer. However, for other L2 technologies, the device may utilize one or more suitable algorithms to determine a unique device identifier. For example, when deployed on a generic L2 technology, the device identifier may be generated as the most significant 128 bits of the output from a SHA-1 computation, whose input is the concatenation of a 64-bit network time protocol (NTP) time and a MAC-48 address converted to an EUI-64 (defined in the IEEE EUI-64 standard). That is, since the L2 entity generally has smaller address (i.e., smaller than 128 bits), the device identifier can be established by using a hash function having two inputs: e.g., the NTP and the MAC address of the device. To this end, it is contemplated that the resulting device identifier will be unique since it is unlikely that two devices will have both the same NTP and MAC address. The resulting device identifier may then be used as a unique virtual link layer address for data packet forwarding purposes.

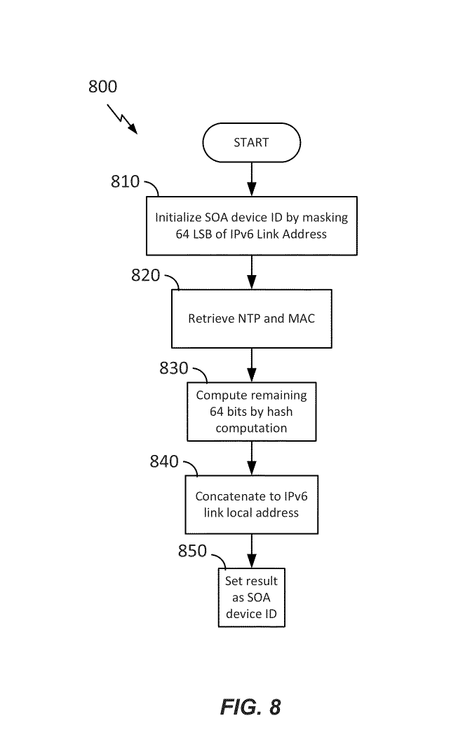

Referring next to FIG. 8, a flow chart illustrating a particular exemplary process 800 for generating an SOA device identifier is provided. As illustrated, process 800 may begin with the utilization of the Link Local Address for IPv6, which has an assigned prefix: 0xFE80::/64. Namely, at act 810, the SOA device identifier is initialized by masking the 64 least significant bits. It is then contemplated that the remaining 64 bits may be generated based on an output from a hash computation, whose input is an NTP time and MAC address associated with the SOA device. Specifically, the NTP time and MAC address are retrieved at act 820, and the hash computation is performed at act 830, as shown. The 64 bit hash computation output is then concatenated to the 64 most significant bits of the IPv6 link local address at act 840. The 128 bit result is then set as the unique SOA device identifier at act 850.

It is contemplated that process 800 will generate an adequately random SOA device identifier which will prevent IPv6 conflicts. To this end, it should be noted that IPv6 also has a neighbor discovery protocol, which resolves IP stack address duplication in the event there is a conflict. Such conflict resolution may be implemented via conflict resolution sub-circuit 630 and/or conflict resolution instructions 632.

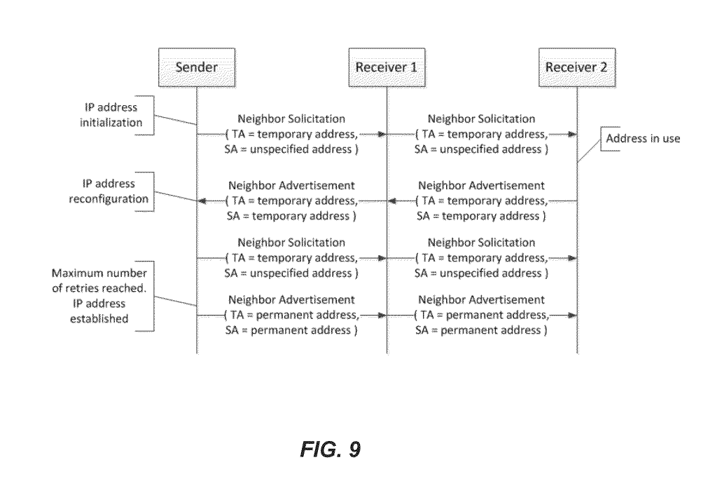

In FIG. 9, a call flow diagram illustrating an exemplary process for resolving a device identifier conflict using IPv6 Neighbor Discovery Protocol (NDP) for Duplicate Address Detection (DAD) is provided. That is, as illustrated in FIG. 9, conventional IPv6 duplicate address detection protocols may be utilized while generating a device identifier in accordance with an aspect of the present disclosure. For instance, FIG. 9 shows a Sender at step 1 sending a neighbor solicitation message to Receiver 1 and Receiver 2 to see if the temporary Target Address, TA, is in conflict with any other addresses on the virtual link layer network. In this case, Receiver 1 has no conflict, but Receiver 2 has a conflict with the Sender's TA address. Receiver 2, at step 2, then sends a neighbor advertisement reporting the conflict to the entire network which will is received by the Sender as well as Receiver 1 (i.e., the network is notified that the temporary TA address is already used). At step 3, the Sender sends another temporary address TA to the network received by Receiver 1 and Receiver 2. At step 4, no conflict message is received, so the Sender establishes the address as the Target Address and both Receiver 1 and Receiver 2 register the Sender TA address.

### Data Packet Routing Via Virtual Link Layer

Referring back to FIG. 5, it is contemplated that each of routing circuit 530 and routing instructions 506b are directed towards forwarding data packets via an SOA bus. In a particular aspect, packets transmitted within the virtual link layer network may include a header, wherein such header may include any of various types of information, such as a protocol version, a packet type (e.g., IP data packet, AODV packet, CDS packet, etc.), a source virtual link layer address, a destination virtual link layer address, a size of a device identifier, a radius, a sequence number, or a payload type.

As illustrated in FIG. 10, each of routing circuit 530 and routing instructions 506b may facilitate such forwarding via any of a plurality of subcomponents. For instance, routing circuit 530 may comprise device discovery sub-circuit 1010, advertisement sub-circuit 1020, broadcast processing sub-circuit 1030, and multicast processing sub-circuit 1040, whereas routing instructions 506b may comprise device discovery instructions 1012, advertisement instructions 1022, broadcast processing instructions 1032, and multicast processing instructions 1042.

In an aspect, it is contemplated that either of routing circuit 530 and/or routing instructions 506b may be configured to unicast rout a data transmission to a target node via an SOA bus according to a device identifier associated with the target node. To this end, it is further contemplated that such unicast routing may comprise maintaining a routing table indexed by a plurality of device identifiers respectively corresponding to virtual link layer nodes within a virtual link layer network. Within such architecture, either of routing circuit 530 and/or routing instructions 506b may thus be configured to present each of a plurality of multi-hop virtual link layer nodes as single hop entities to their corresponding IP layer, as previously discussed with reference to FIG. 4. To facilitate such connectivity, device discovery sub-circuit 1010 and/or device discovery instructions 1012 may be configured to discover other virtual link layer nodes and their corresponding virtual link layer addresses via their respective device identifier advertisements on the SOA bus. Likewise, advertisement sub-circuit 1020 and/or advertisement instructions 1022 may be configured to advertise a particular device's identifier to other virtual link layer nodes via the SOA bus.

In another aspect of the disclosure, either of routing circuit 530 and/or routing instructions 506b may be configured to vary a routing of data according to a neighbor status of a target node. For instance, if the target node is deemed a neighbor, the data transmission may be sent directly to the target node. However, if the target node is deemed a non-neighbor, an ad-hoc on-demand distance vector (AODV) protocol may be utilized, wherein a routing table is populated with a next hop neighbor that can be used to reach the target node. For instance, packets may be unicast routed based on the device identifier, wherein the virtual link layer may maintain a routing table indexed by device identifiers, while the IP layer may maintain a routing table indexed by IP addresses. As stated previously, however, the respective IP layers of devices having the disclosed virtual link layer view all devices within the virtual link layer network as being one hop away. Therefore, the respective IP layers will desirably not need to perform multi-hop routing functions within the virtual link layer network.

It is also contemplated that nodes between two end points of an active communication may be configured to facilitate the routing of data. For instance, in an exemplary implementation, when there is an active communication between two end points, all nodes in the routing path may be configured to automatically refresh the AODV routes. Once the active communication stops, the routes may then be removed within a certain period (e.g., thirty seconds after the communication stops).

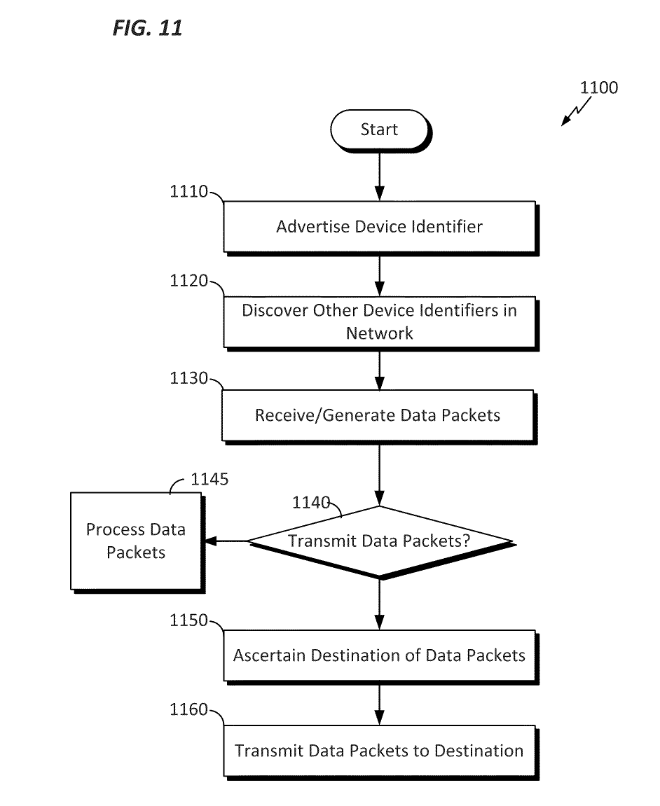

Referring next to FIG. 11, a flowchart illustrating an exemplary data packet routing procedure in accordance with an aspect of the present disclosure is provided. Here, it should be appreciated that process 1100 may be performed by any virtual link layer node including, for example, any of the aforementioned SOA-enabled devices discussed with reference to FIGS. 1-6. As illustrated, process 1100 begins at act 1110 where the device identifier of the virtual link layer node is advertised to other nodes within the virtual link layer network via an SOA bus, wherein the device identifier identifies a virtual link layer service and/or location of the virtual link layer node. Namely, by advertising its device identifier, the other nodes within the virtual link layer network are aware of the device's location for routing purposes, as well as services offered by the device. For instance, over Alljoyn, a virtual link layer service may be advertised as “org.alljoyn.ipservice.sXXXXXX”, where “XXXXX” is the device identifier.

Next, at act 1120, the virtual link layer node discovers the device identifiers of the other nodes within the virtual link layer network. Moreover, because each node within the virtual link layer network advertises its corresponding device identifier via the SOA bus, each of the respective locations and services of nodes in the virtual link layer network are discoverable by other nodes within the network. The link layer service of the virtual link layer node may thus be provided to other virtual link layer nodes in the network via the SOA bus, and the respective link layer services of these other virtual link layer nodes may be provided to the virtual link layer node via the SOA bus as well.

In an aspect of the disclosure, it is contemplated that data packets are either generated or received by virtual link layer nodes. Namely, a virtual link layer node may either generate data packets directed towards a target node, and/or receive data packets from other nodes within the virtual link layer network. At act 1130, data packets are thus generated or received by the virtual link layer node. At act 1140, process 100 then proceeds to determine whether to transmit the data packets. If the virtual link layer node was the intended destination of the data packets, for example, the data packets may then be processed by the virtual link layer node at act 1145. However, if the data packets are to be transmitted, process 1100 proceeds to act 1150 where the destination of the data packets is determined The data packets are then forwarded to their intended destination via the SOA bus at act 1160.

In an aspect, referring back to FIG. 10, each of routing circuit 530 and routing instructions 506b may facilitate receiving/transmitting broadcast messages via broadcast processing sub-circuit 1030 and broadcast processing instructions 1032, respectively. In a particular aspect, either of broadcast processing sub-circuit 1030 and/or broadcast processing instructions 1032 is configured to identify a data transmission received via the SOA bus as a broadcast message according to a sequence number of the data transmission and a device identifier associated with a sender of the data transmission. Similarly, aspects are disclosed for disseminating a data transmission via the virtual link layer as a broadcast message comprising a plurality of broadcast packets by generating a unique sequence number for each of the plurality of broadcast packets.

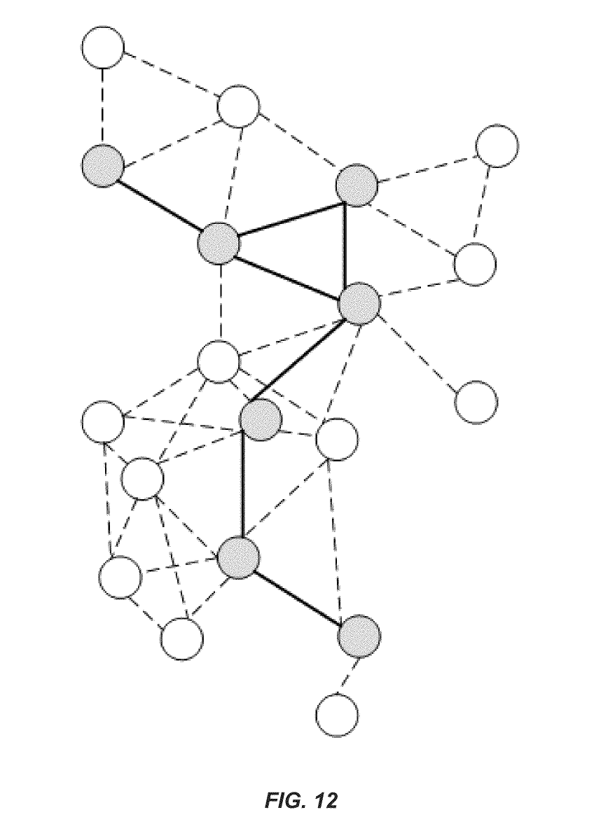

In another aspect, either of broadcast processing sub-circuit 1030 and/or broadcast processing instructions 1032 is configured to enable a capability to transmit a broadcast message via the virtual link layer based on a connected dominating set (CDS) membership, wherein CDS membership is based on neighbor node attributes (e.g., a velocity of node, a number of nodes connected to the virtual link layer node, a rate of change of connections, etc.). In FIG. 12, for instance, a conceptual diagram illustrating an exemplary CDS for transmitting broadcast messages in a virtual link layer network is provided. That is, in accordance with one or more aspects of the present disclosure, a virtual link layer node may support broadcast operations triggered by the IP layer and L2 route discovery protocols, described above. As stated previously, a broadcast message may be uniquely identified by the originator's device identifier and a sequence number. To reduce the flooding that may be caused by large amounts of overhead, the various nodes in the network form a CDS in the virtual link layer network. Various algorithms can be used to create a CDS, some of which are described below. In this way, only the nodes that are members of the CDS transmit the broadcast messages, in a way that enables all nodes in the virtual link layer network to receive the broadcast messages.

In an exemplary “self-elected” CDS construction algorithm, a device is called a backbone node (BN) if it belongs to the CDS. Otherwise, it is called a regular node (RN). Each device is assigned a weight based on its capability, and each device sends messages periodically including its neighbor list and the attributes (weight, BN/RN role, BN/RN convertibility) of each neighbor. When a device has no BN neighbor, it may assume the role of a BN if it has the highest weight among all its RN neighbors. When a device has at least one BN neighbor, it may assume the role of a BN if it has a RN neighbor which has no common BN neighbor with the device itself When a device has at least two BN neighbors, it may assume the role of a BN if any two if its BN neighbors is not connected and it has no common BN neighbor.

Furthermore, the CDS may be pruned as needed. A BN may consider itself non-convertible if any of the following is true: one of its RN neighbors has no BN neighbor; or a pair of its BN neighbors have no common additional BN neighbors. A BN device may resign its BN role if each of the following are true: every one of its RN neighbors has a non-convertible BN neighbor or a BN neighbor that has a higher weight than its own, and such a BN neighbor is a neighbor of the device itself; and every pair of its BN neighbors are connected, or have a common non-convertible BN neighbor, or a common BN neighbor that has a higher weight than its own.

In an exemplary “neighbor-elected” CDS construction algorithm, each device may send messages periodically, wherein the message may include its neighbor list and the CDS role of each neighbor. CDS formation may then be conducted by having each device elect neighbors as designated relays so that every two-hop neighbor of this device can be covered. The device informs it's designated relays of their election, wherein designated relays constitute a CDS.

Aspects for discarding packets of a broadcast message are also contemplated. For instance, in one implementation, broadcast processing sub-circuit 1030 and/or broadcast processing instructions 1032 may be configured to discard packets of a broadcast message having a same source port number and sequence number combination. In another implementation, broadcast processing sub-circuit 1030 and/or broadcast processing instructions 1032 may be configured to decrement a radius field associated with the broadcast message when packets of the broadcast message are forwarded, wherein the broadcast message is entirely discarded when the radius value becomes zero.

In a further aspect, referring again to FIG. 10, each of routing circuit 530 and routing instructions 506b may facilitate receiving/transmitting multicast messages via multicast processing sub-circuit 1040 and multicast processing instructions 1042, respectively. In a particular aspect, either of multicast processing sub-circuit 1040 and/or multicast processing instructions 1042 is configured to disseminate an upper layer multicast message via the virtual link layer by mapping a multicast IP address to a virtual link layer address. In another aspect, either of multicast processing sub-circuit 1040 and/or multicast processing instructions 1042 is configured to disseminate a portion of the upper layer multicast message via a CDS or a forwarding multicast group (FMG).

In some examples, utilizing CDS may act as a fallback when using FMG is inefficient. When using CDS, the sender can broadcast across the CDS, wherein all nodes within the virtual link layer network receive the broadcast message. Here, all nodes examine their own IP address to decide whether or not to process the message.

When using FMG, a set of devices are responsible for forwarding messages of a multicast group from the senders to the receivers. Here, the FMG can be formed by first having the virtual link layer send a message to all registered IP addresses of the virtual link layer network. Then, the virtual link layer examines where the devices that have responded are, and will send the advertisement message to a subset of nodes within the virtual link layer network, which is deemed the Layer 2 (L2) FMG. That is, senders may periodically broadcast an advertisement message to the entire virtual link layer network. When interested, a receiver of the multicast group broadcasts a FMG election message that included it's interested senders' device identifiers and the list of next hop neighbors that are on the shortest paths to the senders. In an aspect of the disclosure, only intermediate nodes that are identified in the list of next hop neighbors should process the FMG election message. The intermediate nodes record the sender identifier and the multicast group which the node is responsible for. The FMG election message is then forwarded all the way back to the senders.

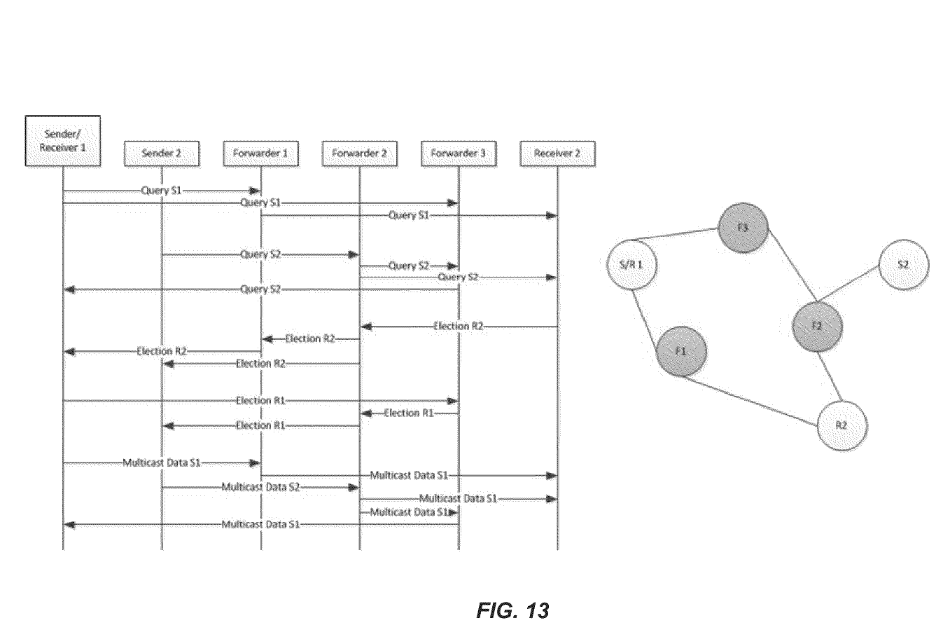

Referring next to FIG. 13, a call flow diagram and schematic diagram illustrating an exemplary process for FMG creation are provided. As illustrated, an Internet gateway message protocol (IGMP) or multicast listener discovery (MLD) query may be disseminated across the CDS, and tunneled through FMG advertisement messages. Further, an IGMP/MLD report may be disseminated across the CDS and tunneled through FMG election messages.

In deciding which nodes to send the advertisement message to, the virtual link layer may perform the following in order to disseminate multicast messages over a multicast tree. First, the virtual link layer may create a mapping between a layer 3 (L3) multicast group membership and a layer 2 (L2) multicast group membership. Then, the L3 multicast group formation messages may be provisioned by a rule. Next, an FMG based on L2 multicast group membership may be formed. Finally, the L3 multicast data messages are provisioned and delivered through the multicast tree. Here, it should be noted that a difference between an FMG and a multicast tree is that the FMG is a union of the multicast tree. Moreover, one multicast tree serves one sender and another tree serves another sender, whereas the FMG accommodates all the trees for all the senders.

In general, it should be noted that one to one mappings between L2 multicast addresses and L3 multicast addresses may not occur since an L3 multicast address has a number of L3 IP addresses. For some operations that have a multicast group there is a unique IP address, wherein a particular group may use a subspace of IP addresses. Here, the IPv4 multicast address space may span 28 bits, with leading address bits of 0b1110, whereas the IPv6 multicast address space may span 112 bits specified within 0xff00::/8. In an aspect of the disclosure, the address space may span 48 bits, so each group will have a corresponding address with the same 48 bits for the unique address.

In a further aspect of the disclosure, the multicast IP address may be mapped to an L2 address. In various aspects of the disclosure, the L2 address may be any suitable value, e.g., an arbitrary value. In some aspects of the disclosure in which IP addresses greater than 48 bits were utilized, zero-valued bits may simply be added. For multicast IP addresses that will have a small number of devices, there may be a one to one mapping between multicast IP address and the multicast group using CDS. For multicast IP address that have a large number of devices, it may not be efficient to use a one to one message, so an FMG multicast scheme may thus not be efficient. In that case, it may be more desirable to use the CDS among the multicast group.

In a further aspect of the disclosure, a virtual link layer driver may add headers to L3 (e.g., IP/ARP, IPv6/NDP) packets generated by the operating system (OS) at the virtual link layer node. Here, such header may include information about the transmitted information, as well as the virtual link layer node. For example, the header may include version information; packet type information (e.g., indicating whether the packet is a data packet, an AODV command packet, a CDS packet, etc.); a source address; a destination address; the size of the address; the number of hops after which the packet is dropped; a sequence number (e.g., utilized to determine duplicate packets); and/or a payload type.

Thus, the virtual link layer driver may map L3 packets (e.g., IP/ARP, IPv6/NDP) packets to appropriate addresses. Here, all L3 broadcast or multicast packets may be mapped to L2 broadcast addresses, e.g., without forward multicast groups. A unique sequence number may be generated and attached by the virtual device driver for every broadcast packet. When FMG is utilized (discussed below), L3 multicast addresses may be mapped to multicast addresses. As for unicast messages, unicast L3 addresses may be mapped to unique addresses.

### Virtual Adapter Creation and Mapping

On virtual link layer nodes with multiple physical adapters, it may be desirable to aggregate such adapters and present them to the upper layers as a single virtual device. It may also be desirable to use a single physical adapter to create multiple virtual adapters. Accordingly, in an aspect of the disclosure, disclosed virtual link layer may be configured to support any of various types of mappings between virtual and physical adapters including, one-to-one, one-to-many, and many-to-one mappings between virtual and physical adapters, wherein the physical adapter could also be an SOA bus. To this end, referring back to FIG. 5, it is contemplated that either of virtual adapter circuit 540 and/or virtual adapter instructions 506c may be configured to generate a virtual adapter from an SOA device ID to facilitate interfacing an IP layer with physical adapters according to any of various virtual-to-physical adapter mappings.

As illustrated in FIG. 14, each of virtual adapter circuit 540 and/or virtual adapter instructions 506c may facilitate such mapping via any of a plurality of subcomponents. For instance, virtual adapter circuit 540 may comprise one-to-one sub-circuit 1410, one-to-many sub-circuit 1420, and many-to-one sub-circuit 1430, whereas virtual adapter instructions 506c may comprise one-to-one instructions 1412, one-to-many instructions 1422, and many-to-one instructions 1432.

In an aspect of the disclosure, each of virtual adapter circuit 540 and/or virtual adapter instructions 506c are configured to maintain property translation tables (PTTs) to facilitate mapping between characteristics of physical adapters and virtual adapters. To this end, it is contemplated that one or more PTTs may be maintained, depending on the corresponding mapping scheme. For instance, either of one-to-one sub-circuit 1410 and/or one-to-one instructions 1412 may be configured to maintain a single property translation table at a single virtual adapter, when the mapping comprises a one-to-one virtual adapter to physical adapter mapping. Here, a virtual adapter provisioning is contemplated in which fields of the single PTT are filled based on on-demand configuration information, wherein configured properties are presented to the upper stack (i.e. IP layer) via the virtual adapter.

To facilitate one-to-many virtual adapter to physical adapter mappings, either of one-to-many sub-circuit 1420 and/or one-to-many instructions 1422 may be configured to maintain multiple property translation tables at a single virtual adapter. Namely, when the mapping comprises a one-to-many virtual adapter to physical adapter mapping, it is contemplated that the provisioned virtual adapter maintains multiple PTTs, wherein fields of each PTT are filled based on common on-demand configuration information and characteristics of associated physical adapters, and wherein configured properties are again presented to the upper stack (i.e. IP layer) via the virtual adapter.

It is further contemplated that either of many-to-one sub-circuit 1430 and/or many-to-one instructions 1432 may be configured to maintain a single corresponding property translation table at each of a plurality of virtual adapters, when the mapping comprises a many-to-one virtual adapter to physical adapter mapping. Here, fields of each PTT are filled based on the characteristics of associated physical adapters and the configured virtual adapter characteristics, wherein configured properties are presented to the upper stack (i.e. IP layer) via each of the provisioned virtual adapters.

It should be noted that desirable egress and ingress shortcuts are achieved via the disclosed mappings. For instance, with respect to one-to-one virtual to physical adapter mappings, IP egress packets from the upper stack may not need to traverse down the physical driver, if the packet is destined to an IP address in the routable list of one of the multiple virtual adapters. In these cases, the IP packet is directly transferred between the sending queue of one virtual adapter to the receiving queue of another virtual adapter.

Similarly, with respect to one-to-many virtual to physical adapter mappings, ingress packets may not need to traverse up the IP stack from the physical adapter, if the packet is destined to an IP address in the routable list of the virtual adapter. In these cases, the virtual adapter performs the hardware address resolution directly, strips off the hardware header and prefixes a new one. The re-assembled packet is subsequently sent out from corresponding physical adapter.

Referring next to FIG. 15, a flow chart illustrating an exemplary virtual adapter generation procedure according to some aspects of the disclosure is provided. As illustrated, process 1500 begins with a mapping type determined at act 1510. Here, it is contemplated that such mapping may be any of the aforementioned one-to-one, one-to-many, or many-to-one virtual to physical adapter mappings. Next, at act 1520, corresponding SOA device identifiers are retrieved. Fields for the appropriate property translation tables are then populated at act 1530, and process 1500 then concludes at act 1540 with the generation of the virtual adapter(s).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method to facilitate a mobile adhoc network comprising:
generating a virtual adapter to facilitate creating a virtual link layer between a virtual link layer node and at least one other virtual link layer node; and
interfacing the virtual link layer with an Internet Protocol (IP) layer via the virtual adapter, wherein data transmitted over the virtual link layer is accessible to the IP layer via the virtual adapter.

2. The method of claim 1, wherein the virtual link layer node and the at least one other virtual link layer node are connected to the virtual link layer via a same type of access network.

3. The method of claim 1, wherein the virtual link layer node and the at least one other virtual link layer node are connected to the virtual link layer via different access network types.

4. The method of claim 3, wherein the different access network types comprise at least two of a Bluetooth network, a wireless local area network (WLAN), a wireless wide area network (WWAN), a Long-Term Evolution (LTE) Direct network, or an Ethernet network.

5. The method of claim 1, wherein the virtual link layer facilitates at least one of discovery or communication within a service oriented architecture (SOA) network.

6. The method of claim 5, wherein the SOA network is an AllJoyn network.

7. The method of claim 1, further comprising at least one of:
advertising a device identifier associated with the virtual link layer node to other virtual link layer nodes via a service oriented architecture (SOA) bus, wherein the device identifier identifies a link layer service of the virtual link layer node,
discovering a link layer service of a different virtual link layer node based on a device identifier corresponding to the different virtual link layer node advertised over the SOA bus, or
providing at least one of the link layer service of the virtual link layer node to the different virtual link layer node via the SOA bus, or the link layer service of the different virtual link layer node to the virtual link layer node via the SOA bus.

8. The method of claim 1, further comprising deriving a device identifier associated with the virtual link layer node based on aspects of a virtual link layer network on which the virtual link layer node is deployed.

9. The method of claim 8, wherein the deriving comprises configuring the device identifier according to different bit lengths.

10. The method of claim 8, wherein the deriving comprises:
utilizing an existing identifier of the virtual link layer node associated with the virtual link layer network as the device identifier, or
deriving the device identifier from an existing media access control (MAC) address associated with a physical access network connecting the virtual link layer node with the at least one other virtual link layer node.

11. The method of claim 8, wherein the deriving comprises deriving the device identifier from a network time protocol (NTP) time associated with the virtual link layer node.

12. The method of claim 8, wherein the deriving comprises performing a hash computation, and wherein at least one input of the hash computation is an aspect associated with the virtual link layer node.

13. The method of claim 1, further comprising presenting each of a plurality of multi-hop virtual link layer nodes as single hop entities to the IP layer.

14. The method of claim 1, further comprising including a header to each packet sent from the virtual link layer node, the header including at least one of a protocol version, a packet type, a source virtual link layer address, a destination virtual link layer address, a size of a device identifier, a radius, a sequence number, or a payload type.

15. The method of claim 1, further comprising unicast routing a data transmission to a target node via the virtual link layer according to a device identifier associated with the target node.

16. The method of claim 15, wherein the unicast routing further comprises maintaining a routing table indexed by a plurality of device identifiers respectively corresponding to virtual link layer nodes within a virtual link layer network.

17. The method of claim 15, the unicast routing varying according to a neighbor status of the target node,
wherein, the data transmission is sent directly to the target node via the virtual link layer, if the target node is deemed a neighbor, and
wherein, the unicast routing comprises dynamically determining a path to the target node via an adhoc on demand vector (AODV) protocol, if the target node is deemed a non-neighbor, wherein a routing table is populated with a next hop neighbor that can be used to reach the target node.

18. The method of claim 1, further comprising enabling a capability to transmit a broadcast message via the virtual link layer, the enabling based on a self-elected designation of the virtual link layer node within a connected dominating set (CDS), wherein a first designation enables the virtual link layer node to transmit broadcast messages, and wherein a second designation does not enable the virtual link layer node to transmit broadcast messages.

19. The method of claim 18, further comprising:
transmitting a virtual link layer node information to neighbor nodes, the virtual link layer node information including an address of the virtual link layer node and a weight of the virtual link layer node, wherein the weight of the virtual link layer node is based on node attributes associated with the virtual link layer node; and
transmitting neighbor node information to neighbor nodes, the neighbor node information including an address and weight for each of the neighbor nodes, wherein the weight for each of the neighbor nodes is based on node attributes respectively associated with each of the neighbor nodes.

20. The method of claim 19, wherein the node attributes include at least one of a velocity of node, a number of nodes connected to the virtual link layer node, or a rate of change of connections.

21. The method of claim 1, further comprising identifying a data transmission received via the virtual link layer as a broadcast message, the broadcast message identified according to a sequence number of the data transmission and a virtual link layer node identifier associated with a sender of the data transmission.

22. The method of claim 21, discarding packets of the broadcast message having a same source port number and sequence number combination.

23. The method of claim 21, further comprising decrementing a radius field associated with the broadcast message when packets of the broadcast message are forwarded, wherein the broadcast message is entirely discarded when the radius value becomes zero.

24. The method of claim 1, further comprising disseminating a data transmission via the virtual link layer as a broadcast message comprising a plurality of broadcast packets, the disseminating comprising generating a unique sequence number for each of the plurality of broadcast packets.

25. The method of claim 1, further comprising disseminating an upper layer multicast message via the virtual link layer, the disseminating comprising:
mapping a multicast IP address to a virtual link layer address;
transmitting the multicast message via a connected dominating set (CDS); or
transmitting the multicast message via a forwarding multicast group.

26. The method of claim 1, wherein the interfacing comprises mapping at least one virtual adapter to at least one physical adapter.

27. The method of claim 26, wherein the mapping comprises:
maintaining a single property translation table at a single virtual adapter, when the mapping comprises a one-to-one virtual adapter to physical adapter mapping;
maintaining multiple property translation tables at the single virtual adapter, when the mapping comprises a one-to-many virtual adapter to physical adapter mapping; or
maintaining a single corresponding property translation table at each of a plurality of virtual adapters, when the mapping comprises a many-to-one virtual adapter to physical adapter mapping.

28. A device comprising:
a virtual adapter circuit configured to generate a virtual adapter to facilitate creating a virtual link layer between a virtual link layer node and at least one other virtual link layer node; and
a routing circuit configured to interface the virtual link layer with an Internet Protocol (IP) layer via the virtual adapter, wherein data transmitted over the virtual link layer is accessible to the IP layer via the virtual adapter.

29. A device comprising:
means for generating a virtual adapter to facilitate creating a virtual link layer between a virtual link layer node and at least one other virtual link layer node; and
means for interfacing the virtual link layer with an Internet Protocol (IP) layer via the virtual adapter, wherein data transmitted over the virtual link layer is accessible to the IP layer via the virtual adapter.

30. A non-transitory machine-readable storage medium having one or more instructions stored thereon, which when executed by at least one processor causes the at least one processor to:
generate a virtual adapter to facilitate creating a virtual link layer between a virtual link layer node and at least one other virtual link layer node; and
interface the virtual link layer with an Internet Protocol (IP) layer via the virtual adapter, wherein data transmitted over the virtual link layer is accessible to the IP layer via the virtual adapter.
